(19) United States
(12) Patent Application Publication
(10) Pub. No.: US 2009/0091254 A1
(43) Pub. Date: Apr. 9, 2009

(54) Organic electroluminescence device and method for manufacturing the same

(75) Inventors: Yun Sik Jeong, Busan-si (KR); Joon Young Heo, Gyeonggi-do (KR)

Correspondence Address: HOLLAND & KNIGHT LLP, 2099 PENNSYLVANIA AVE, SUITE 100, WASHINGTON, DC, 20006, US

(73) Assignee: LG.DISPLAY CO., LTD., Seoul (KR)

(21) Appl. No.: 12/285,551

(22) Filed: Oct. 8, 2008

(30) Foreign Application Priority Data
Oct. 8, 2007 (KR) 10-2007-0100972
Oct. 23, 2007 (KR) 10-2007-0106588
Sep. 5, 2008 (KR) 10-2008-0087897
Sep. 5, 2008 (KR) 10-2008-0087900

(51) Int. Cl. H01J 63/04; H01J 9/00

(52) U.S. Cl. 313/504; 445/46

(57) ABSTRACT

An organic electroluminescence device and a method for manufacturing the same, in which a thin film transistor is covered by one electrode of a luminescence device, a shield layer, or an insulating layer, so that it is prevented from being exposed to natural light or X-rays, are disclosed. The organic electroluminescence device includes a semiconductor layer on the substrate while including a source region, a channel region, and a drain region, a gate insulating film on the substrate while including first contact holes, a gate electrode on the gate insulating film over the channel region, an interlayer insulating film on the gate insulating film while including second contact holes, source and drain electrodes on the interlayer insulating film while being electrically connected to the source and drain regions via the first and second contact holes, a planarizing film on the resulting structure while including a third contact hole, a first electrode of a luminescence device on the planarizing film such that the first electrode covers the semiconductor layer while being electrically connected to the drain electrode via the third contact hole, an organic luminescence layer on the first electrode, and a second electrode of the luminescence device on the organic luminescence layer.

This application claims the benefits of Korean Patent Application No. 10-2007-100972, filed on Oct. 8, 2007, of Korean Patent Application No. 10-2007-106588, filed on Oct. 23, 2007, of Korean Patent Application No. 10-2008-087897, filed on Sep. 5, 2008, and of Korean Patent Application No. 10-2008-087900, filed on Sep. 5, 2008, which are hereby incorporated by reference as if fully set forth herein.

### BACKGROUND OF THE INVENTION

1. Field of the Invention

The present invention relates to an organic electroluminescence device, and more particularly, to an organic electroluminescence device and a method for manufacturing the same, which are capable of preventing a thin film transistor included in the device from being exposed to natural light or X-rays.

2. Discussion of the Related Art

In accordance with the advent of an age of multimedia, development of a display device capable of more finely rendering colors more approximate to natural colors while having a larger size is being required. However, the current cathode ray tubes (CRTs) have a limitation in realizing a large screen of 40 inches or more. For this reason, organic electroluminescence devices, liquid crystal displays (LCDs), plasma display panels (PDPs), and projection televisions (TVs) are being rapidly developed so that the applications thereof can be extended to a high-quality image field.

In the organic electroluminescence device, light is emitted as electrons and holes disappear after being coupled in pairs when a charge is injected into an organic film formed between a cathode and an anode. Thus, the organic electroluminescence device can be formed on a flexible transparent substrate made of, for example, a plastic material. Also, the organic electroluminescence device can be driven at a low voltage (about 10V or less), as compared to a PDP or an inorganic electroluminescence device. Moreover, the organic electroluminescence device has advantages of relatively low power consumption and excellent color sensation. Thus, the organic electroluminescence device is being highlighted as a next-generation display. In order to enable the organic electroluminescence device to be driven at a low voltage, it is important to maintain the organic film to be very thin and uniform. For example, the total thickness of the organic film should be about 100 to 200 nm. Furthermore, the device should have stability.

In accordance with the sub-pixel driving method, the organic electroluminescence device is classified into a passive matrix type, in which sub-pixels are driven through switch control of electrical signals, and an active matrix type, in which sub-pixels are driven using thin film transistors (TFTs).

Hereinafter, a conventional active matrix organic electroluminescence device will be described.

The conventional active matrix organic electroluminescence device includes TFTs formed on a transparent substrate, a planarizing film formed over the entire upper surface of the resulting structure including the TFTs, and a luminescence device formed on the planarizing film.

Each TFT includes an active layer defined with a source region, a drain region, and a channel region, a gate insulating film formed over the entire upper surface of the resulting structure including the active layer, a gate electrode formed on a portion of the gate insulating film arranged over the channel region, and an interlayer insulating film formed over the entire upper surface of the resulting structure including the gate electrode. The TFT also includes a source electrode and a drain electrode, which are formed on the interlayer insulating film while being electrically connected to the source and drain regions, respectively.

The luminescence device includes an anode electrode formed on the planarizing film while being electrically connected to the drain electrode of each TFT, an organic luminescence layer formed on the anode electrode, and a cathode electrode formed on the organic luminescence layer.

The organic luminescence layer includes a hole transfer layer, red (R), green (G), and blue (B) emitting layers, and an electron transfer layer. The hole transfer layer includes a hole injection layer and a hole transport layer. The electron transfer layer includes an electron transport layer and an electron injection layer.

However, the above-mentioned conventional organic electroluminescence device has the following problems.

FIG. 1 is a graph depicting a variation in the electrical characteristics of the transistor in the organic electroluminescence device caused by external light.

As shown in FIG. 1, the organic electroluminescence device exhibits a degradation in electrical characteristics when it is aged in a state of being exposed to external light, namely, a light ON_aging state, as compared to the case in which it is aged in a state of being shielded from external light, namely, in a light OFF_aging state. That is, characteristics associated with leakage current, etc. is degraded when external light is irradiated onto the active layer of the TFTs, as compared to the case in which no external light is irradiated onto the active layer.

Furthermore, the TFTs may be damaged when it is exposed to X-rays in a deposition process for the luminescence device (the anode electrode, organic luminescence layer, and cathode electrode). The electrical contact degree between the drain electrode and the anode electrode may also be lowered.

### SUMMARY OF THE INVENTION

Accordingly, the present invention is directed to an organic electroluminescence device and a method for manufacturing the same that substantially obviate one or more problems due to limitations and disadvantages of the related art.

An object of the present invention is to provide an active matrix organic electroluminescence device and a method for manufacturing the same, which are capable of protecting a thin film transistor included in the device from external light, and preventing the thin film transistor from being exposed to X-rays in a luminescence device deposition process, thereby preventing a degradation in the characteristics of the thin film transistor.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an organic electroluminescence device comprises: a substrate; a semiconductor layer on the substrate, the semiconductor layer including a source region, a channel region, and a drain region; a gate insulating film on the substrate including the semiconductor layer, the gate insulating film including first contact holes respectively arranged on the source and drain regions; a gate electrode on a portion of the gate insulating film over the channel region; an interlayer insulating film on an entire upper surface of the gate insulating film including the gate electrode, the interlayer insulating film including second contact holes respectively arranged on the source and drain regions; source and drain electrodes on the interlayer insulating film such that the source and drain electrodes are electrically connected to the source and drain regions via the first and second contact holes, respectively; a planarizing film on an entire upper surface of the resulting structure including the source and drain electrodes, the planarizing film including a third contact hole arranged on the drain electrode; a first electrode of a luminescence device on the planarizing film such that the first electrode covers the semiconductor layer while being electrically connected to the drain electrode via the third contact hole; an organic luminescence layer on the first electrode; and a second electrode of the luminescence device on the organic luminescence layer.

In another aspect of the present invention, an organic electroluminescence device comprises: a transparent substrate; a semiconductor layer on the substrate, the semiconductor layer including a source region, a channel region, and a drain region; a gate insulating film on the substrate including the semiconductor layer, the gate insulating film including first contact holes respectively arranged on the source and drain regions; a gate electrode on a portion of the gate insulating film over the channel region; an interlayer insulating film on an entire upper surface of the gate insulating film including the gate electrode, the interlayer insulating film including second contact holes respectively arranged on the source and drain regions; source and drain electrodes on the interlayer insulating film such that the source and drain electrodes are electrically connected to the source and drain regions via the first and second contact holes, respectively; a planarizing film on an entire upper surface of the resulting structure including the source and drain electrodes, the planarizing film including a third contact hole arranged on the drain electrode; a first electrode of a luminescence device on the planarizing film such that the first electrode is electrically connected to the drain electrode via the third contact hole; a shield layer on or beneath the first electrode such that the shield layer covers the semiconductor layer; an organic luminescence layer on the first electrode; and a second electrode of the luminescence device on the organic luminescence layer.

In another aspect of the present invention, an organic electroluminescence device comprises a plurality of cells each including a display area provided with a first transistor and a luminescence device, and a non-display area provided with a second transistor for driving the cell, wherein the luminescence device comprises a first electrode, a luminescence layer, and a second electrode; and wherein the first electrode covers the first and second transistors.

In another aspect of the present invention, an organic electroluminescence device comprises: a thin film transistor on a transparent substrate, the thin film transistor including a gate electrode, a source electrode, and a drain electrode; a first electrode of a luminescence device formed to be electrically connected to the drain electrode; an insulating film formed to cover the thin film transistor and to overlap opposite ends of the first electrode; a luminescence layer on the first electrode, the luminescence layer emitting light as electrons and holes disappear after being coupled in pairs; and a second electrode of the luminescence device on the luminescence layer.

In another aspect of the present invention, a method for manufacturing an organic electroluminescence device comprises: forming a semiconductor on a substrate, the semiconductor layer including a source region, a channel region, and a drain region; forming a gate insulating film on the substrate including the semiconductor layer; forming a gate electrode on a portion of the gate insulating film over the channel region; forming an interlayer insulating film on an entire upper surface of the gate insulating film including the gate electrode; selectively removing the gate insulating film and the interlayer insulating film, thereby forming first contact holes respectively arranged on the source and drain regions; forming source and drain electrodes on the interlayer insulating film such that the source and drain electrodes are electrically connected to the source and drain regions via the first contact holes, respectively; forming a planarizing film on an entire upper surface of the resulting structure including the source and drain electrodes; selectively removing the planarizing film, thereby forming a second contact hole arranged on the drain electrode; forming a first electrode of a luminescence device on the planarizing film such that the first electrode covers the semiconductor layer while being electrically connected to the drain electrode via the second contact hole; forming an organic luminescence layer on the first electrode; and forming a second electrode of the luminescence device on the organic luminescence layer.

In another aspect of the present invention, a method for manufacturing an organic electroluminescence device comprises: forming a semiconductor on a transparent substrate, the semiconductor layer including a source region, a channel region, and a drain region; forming a gate insulating film on the substrate including the semiconductor layer; forming a gate electrode on a portion of the gate insulating film over the channel region; forming an interlayer insulating film on an entire upper surface of the gate insulating film including the gate electrode; selectively removing the gate insulating film and the interlayer insulating film, thereby forming first contact holes respectively arranged on the source and drain regions; forming source and drain electrodes on the interlayer insulating film such that the source and drain electrodes are electrically connected to the source and drain regions via the first contact holes, respectively; forming a planarizing film on an entire upper surface of the resulting structure including the source and drain electrodes; selectively removing the planarizing film, thereby forming a second contact hole arranged on the drain electrode; forming a first electrode of a luminescence device on the planarizing film such that the first electrode is electrically connected to the drain electrode via the second contact hole; forming a shield layer on or beneath the first electrode such that the shield layer covers the semiconductor layer; forming an organic luminescence layer on the first electrode; and forming a second electrode of the luminescence device on the organic luminescence layer.

In still another aspect of the present invention, a method for manufacturing an organic electroluminescence device comprises: forming a thin film transistor on a transparent substrate, the thin film transistor including a gate electrode, a source electrode, and a drain electrode; forming a planarizing film on an entire upper surface of the substrate including the thin film transistor, and forming a contact hole through the planarizing film such that the drain electrode is exposed through the contact hole; forming a first electrode of a luminescence device such that the first electrode is electrically connected to the drain electrode via the contact hole; forming an insulating film on the planarizing film such that the insulating film covers the semiconductor layer and overlaps with opposite ends of the first electrode; and forming a second electrode of the luminescence device on the first electrode.

The organic electroluminescence device and manufacturing method thereof according to the present invention provide the following effects.

First, it is possible to protect thin film transistors from X-rays generated during a deposition process for the luminescence layer in the manufacture of the organic electroluminescence device.

Second, it is possible to preserve desired electrical characteristics of thin film transistors against natural light where the organic electroluminescence device is of an active matrix type.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a graph depicting a variation in the electrical characteristics of a transistor in an organic electroluminescence device caused by external light;

FIG. 2 is a schematic view illustrating a transistor and a first electrode (anode) arranged in a non-luminescence region of an organic electroluminescence device according to the present invention;

FIG. 3 is a sectional view illustrating an organic electroluminescence device according to a first embodiment of the present invention;

FIG. 4 is a sectional view illustrating an organic electroluminescence device according to a second embodiment of the present invention;

FIGS. 5A to 5E are sectional views illustrating sequential processes of a method for manufacturing the organic electroluminescence device according to the first embodiment of the present invention;

FIG. 6 is a sectional view illustrating an organic electroluminescence device according to a third embodiment of the present invention;

FIG. 7 is a sectional view illustrating an anode and an insulating layer in the organic electroluminescence device according to the third embodiment of the present invention;

FIGS. 8A to 8F are sectional views illustrating sequential processes of a method for manufacturing the organic electroluminescence device according to the third embodiment of the present invention.

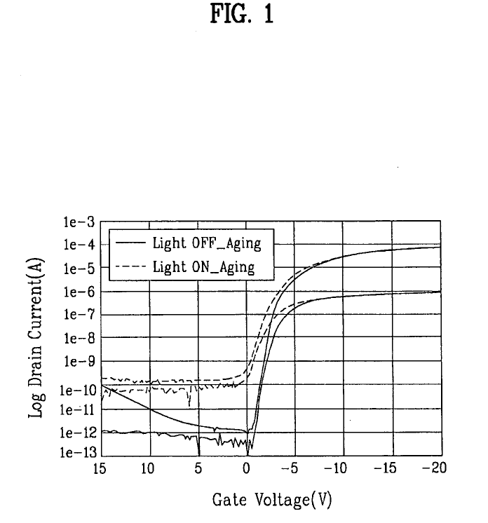

### DETAILED DESCRIPTION OF THE INVENTION

Reference will now be made in detail to the preferred embodiments of the present invention associated with an organic electroluminescence device and a method for manufacturing the same, examples of which are illustrated in the accompanying drawings.

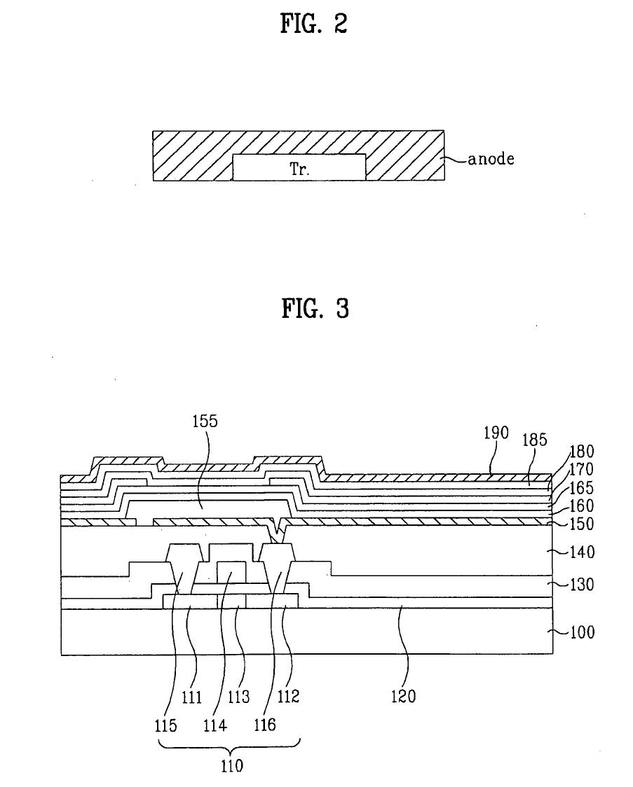

FIG. 2 is a schematic view illustrating a transistor and a first electrode (anode) arranged in a non-luminescence region of an organic electroluminescence device according to the present invention.

As shown in FIG. 2, the organic electroluminescence device has a feature in that the first electrode covers the transistor Tr′. The transistor, which may be a thin film transistor, includes a source region, a drain region, and a channel region.

FIG. 3 is a sectional view illustrating an organic electroluminescence device according to a first embodiment of the present invention. Hereinafter, the organic electroluminescence device according to the illustrated embodiment will be described with reference to FIG. 3.

The organic electroluminescence device according to the first embodiment of the present invention is of an active matrix type, and includes a substrate 100. The organic electroluminescence device also includes a plurality of thin film transistors (TFTs) 110, a planarizing film 140, and a luminescence device including components 150, 160, 165, 170, 180, 185, and 190, all of which are sequentially laminated on the substrate 100.

The substrate 100 is comprised of a transparent substrate made of, for example, glass, quartz, or sapphire. Alternatively, the substrate 100 may be comprised of an opaque substrate. Although not shown, an insulating layer is formed between the transparent substrate 100 and the TFTs 110, to prevent impurity contained in the substrate 100 from penetrating into active layers of the TFTs 110.

Each TFT 110 is configured as follows.

That is, each TFT 110 includes an active layer formed on the substrate 100 while being defined with a source region 111, a drain region 112, and a channel region 113, a gate insulating film 120 formed over the entire upper surface of the resulting structure including the active layer, a gate electrode 114 formed on a portion of the gate insulating film 120 arranged over the channel region 113, and an interlayer insulating film 130 formed over the entire upper surface of the resulting structure including the gate electrode 114. Each TFT 110 also includes a source electrode 115 and a drain electrode 116 formed on the interlayer insulating film 130 while extending through contact holes formed through the gate insulating film 120 and interlayer insulating film 130, respectively, so that the source electrode 115 and drain electrode 116 are electrically connected to the source region 111 and drain region 112, respectively.

Each of the source electrode 115 and drain electrode 116 is made of a material selected from the group consisting of chromium (Cr), copper (Cu), gold (Au), nickel (Ni), silver (Ag), tantalum (Ta), aluminum (Al), and aluminum-neodymium (AlNd), and has a thickness of 200 to 500 nm.

The planarizing film 140 is formed over the entire upper surface of the transparent substrate 100 including the TFTs 110, to planarize pixel regions. The planarizing film 140 may be made of an organic insulating film such as an acryl-based organic compound, polyimide, benzocyclobutene (BCB), or perfluorocyclobutane (PFCB). Alternatively, the planarizing film 140 may be made of an inorganic insulating material such as silicon nitride.

A contact hole is formed through a portion of the planarizing film 140 arranged over the drain electrode 116, in order to electrically connect a first electrode 150 of the luminescence device, which will be described later, to the drain electrode 116.

The first electrode 150 of the luminescence device, which will be electrically connected to the drain electrode 116 via the contact hole, is formed on the planarizing film 140. The first electrode 150 is comprised of a metal layer having a single layer structure or a multilayer structure, in order to shield light, and to protect the TFTs 110 from X-rays during the formation of the luminescence layer and second electrode. The first electrode 150 may be made of one or more selected from the group consisting of titanium (Ti), molybdenum (Mo), chromium (Cr), copper (Cu), gold (Au), nickel (Ni), silver (Ag), tantalum (Ta), aluminum (Al), aluminum-neodymium (AlNd), and tungsten (W), to have a single layer structure or a multilayer structure. Preferably, the thickness and material of the first electrode 150 are determined so that the first electrode 150 can not only shield natural light, but also have an X-ray transmissivity of 0.001 to 1.0%.

Thus, the first electrode 150 extends over each TFT 110, to cover the TFT 110 (in particular, the active layer of the TFT 110). The material of the first electrode 150 also covers TFTs arranged in a non-luminescence region (not shown) (driving part).

Since the first electrode 150 covers the TFTs, it is possible to prevent the TFTs from being exposed to natural light or X-rays, and thus to prevent a degradation in the characteristics of the TFTs.

A pixel isolation film 155 is formed between adjacent cells on the planarizing film 140. The pixel isolation film 155 may be made of an organic insulating material such as a silicon nitride (SiNₓ) or a silicon oxide (SiO₂).

An organic luminescence layer and a second electrode 190 are sequentially formed on the upper surface of the resulting structure including the pixel isolation film 155 and first electrode 150.

The organic luminescence layer includes a hole injection layer 160, a hole transfer layer 165, an emitting layer 170, an electron transfer layer 180, and an electron injection layer 185, which are sequentially laminated in that order. The second electrode 190 of the organic electroluminescence device is laminated on the organic luminescence layer.

The electron transfer layer 180 is arranged between the emitting layer 170 and the second electrode 190. Accordingly, most electrons injected from the second electrode 190 into the emitting layer 170 tend to move toward the first electrode 150, in order to recombine with holes. On the other hand, the hole transfer layer 165 is arranged between the first electrode 150 and the emitting layer 170. Accordingly, the electrons injected into the emitting layer 170 are blocked by the interface between the emitting layer 170 and the hole transfer layer 165, so that they can no longer move toward the first electrode 150. As a result, the electrons stay only in the emitting layer 170. Thus, an enhancement in recombination efficiency is achieved.

The lamination order of the organic luminescence layer can be reversed. That is, the electron injection layer, electron transfer layer, emitting layer, hole transfer layer, and hole injection layer may be sequentially laminated, in that order, on the first electrode 150. In this case, the second electrode 190 is laminated on the hole injection layer.

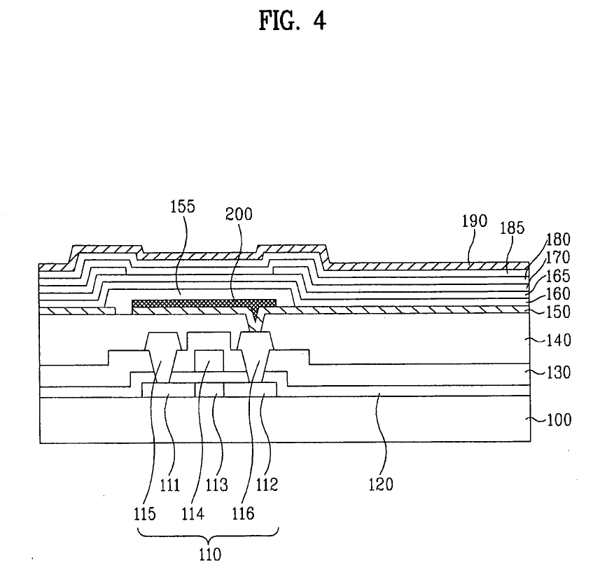

FIG. 4 is a sectional view illustrating an organic electroluminescence device according to a second embodiment of the present invention.

The organic electroluminescence device according to the second embodiment of the present invention is different from that of the first embodiment in that the first electrode is comprised of a transparent conductive layer, the second electrode is comprised of a metal layer, and a shield layer 200 is additionally formed over or beneath the first electrode, to cover the TFTs, and thus to shield natural light or X-rays. The remaining configuration of the organic electroluminescence device according to the second embodiment of the present invention is identical to that of the first embodiment shown in FIG. 3, so no detailed description thereof will be given.

In accordance with the second embodiment, TFTs 110, each of which includes an active layer, a gate electrode 114, a source electrode 115, and a drain electrode 116, as described above, are formed on a transparent substrate 100 made of glass, quartz, or sapphire. A planarizing film 140 is formed over the entire upper surface of the transparent substrate 100 including the TFTs 110, to planarize a pixel region.

A contact hole is formed through a portion of the planarizing film 140 arranged over the drain electrode 116, in order to electrically connect a first electrode 150 of the luminescence device, which will be described later, to the drain electrode 116.

The first electrode 150 of the luminescence device, which will be electrically connected to the drain electrode 116 via the contact hole, is formed on the planarizing film 140. A shield layer 200 is formed over or beneath the first electrode 150, to cover the TFTs 110.

The first electrode 150 is made of a transparent conductive material capable of transmitting light, for example, indium tin oxide (ITO) or indium zinc oxide (IZO). The shield layer 200 is comprised of a metal layer having a single layer structure or a multilayer structure, in order to shield light, and to protect the TFTs 110 from X-rays during the formation of a luminescence layer and a second electrode, which will be described later. The shield layer 200 may be made of one or more selected from the group consisting of titanium (Ti), molybdenum (Mo), chromium (Cr), copper (Cu), gold (Au), nickel (Ni), silver (Ag), tantalum (Ta), aluminum (Al), aluminum-neodymium (AlNd), and tungsten (W), to have a single layer structure or a multilayer structure. Preferably, the thickness and material of the shield layer 200 are determined so that the shield layer 200 can not only shield natural light, but also have an X-ray transmissivity of 0.001 to 1.0%.

Thus, the shield layer 200 extends over each TFT 110, to cover the TFT 110 (in particular, the active layer of the TFT 110). The material of the first shield layer 200 also covers TFTs arranged in a non-luminescence region (not shown) (driving part).

Since the shield layer 200 covers the TFTs, it is possible to prevent the TFTs from being exposed to natural light or X-rays, and thus to prevent a degradation in the characteristics of the TFTs.

An organic luminescence layer and a second electrode 190 are sequentially formed on the first electrode 150.

The second electrode 190 is comprised of a metal layer.

Hereinafter, a method for manufacturing the organic electroluminescence device according to the first embodiment of the present invention will be described.

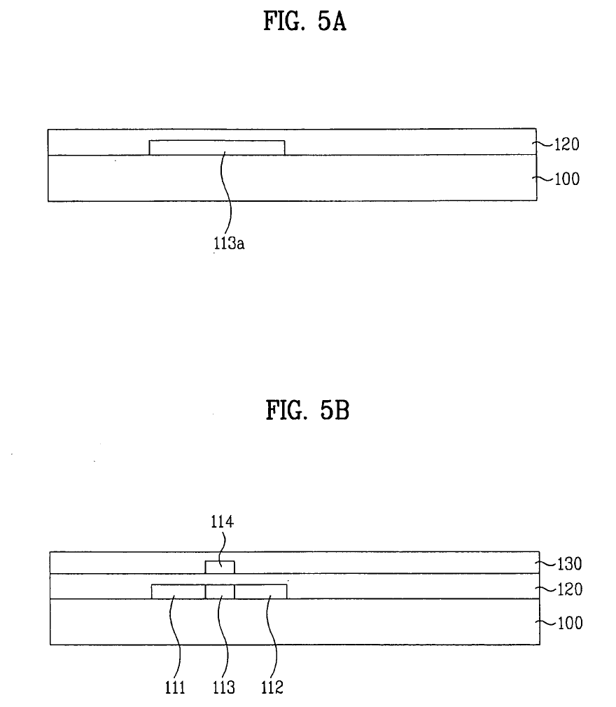

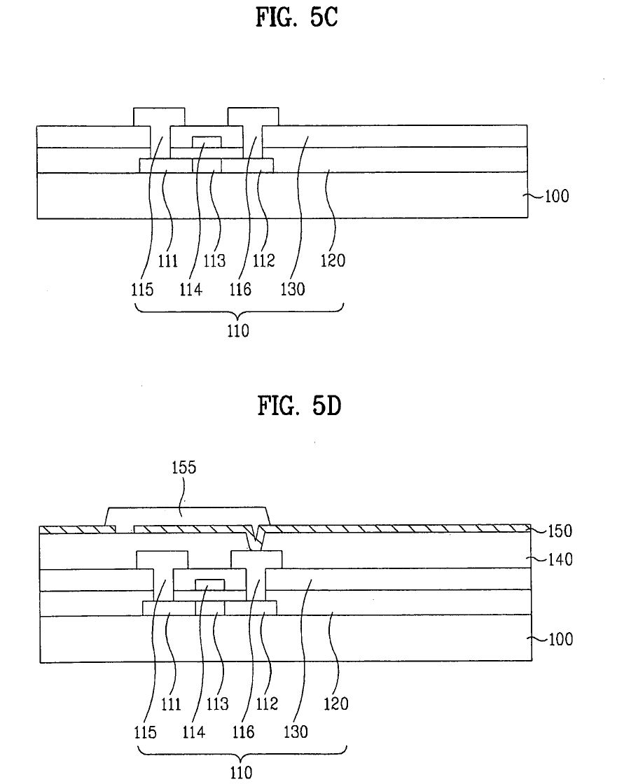

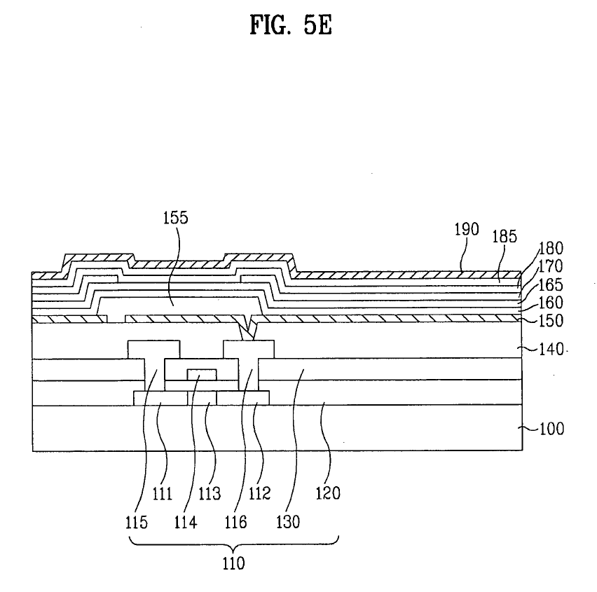

FIGS. 5A to 5E are sectional views illustrating sequential processes of the method for manufacturing the organic electroluminescence device according to the first embodiment of the present invention.

As shown in FIG. 5A, the transparent substrate 100, which is made of glass, quartz, or sapphire, is first prepared. An amorphous silicon film is then formed to a thickness of about 200 to 800 Å over the transparent substrate 100, using a low pressure chemical vapor deposition method or plasma enhanced chemical vapor deposition method. The amorphous silicon film is then crystallized into a polysilicon film, using a laser annealing method or the like. Of course, a polysilicon film may be directly deposited, in place of the amorphous silicon film.

Thereafter, the polysilicon film is patterned in accordance with a photo-etching process, to form the active layer 113a of the TFT 110 in each unit pixel. The gate insulating film 120 is then deposited over the entire upper surface of the resulting structure including the active layer 113a.

As shown in FIG. 5B, the gate electrode 114 is subsequently formed on a portion of the gate insulating film 120 arranged over the active layer 113a. In detail, the formation of the gate electrode 114 is achieved by depositing aluminum-neodymium (AlNd) to a thickness of about 1,500 to 5,000 Å over the gate insulating film 120, and then patterning the deposited aluminum-neodymium (AlNd), using a photo-etching process.

Using the gate electrode 114 as a mask, impurity ions are implanted into the active layer 113a. The injected impurity ions are then activated, to form the source region 111 and drain region 112 of the TFT 110. In this case, no impurity ion is implanted into a portion of the active layer 113 arranged beneath the gate electrode 114. As a result, the channel region 113 is naturally formed.

Thereafter, a silicon oxide film or a silicon nitride film is deposited over the entire upper surface of the resulting structure including the gate electrode 114, to form the interlayer insulating film 130.

As shown in FIG. 5C, the gate insulating film 120 and interlayer insulating film 130 are selectively removed such that the source region 111 and drain region 112 are exposed, thereby forming contact holes.

At least one metal layer is deposited over the interlayer insulating film 130. The metal layer is then selectively removed to form the source electrode 115 and drain electrode 116, which are electrically connected to the source region 111 and drain region 112, respectively.

As shown in FIG. 5D, the planarizing film 140 is then formed over the entire upper surface of the interlayer insulating film 130 including the TFT 110. The planarizing film 140 functions to planarize the first electrode of the luminescence device, which will be subsequently formed. The formation of the planarizing film 140 is achieved by depositing an organic or inorganic insulating film to a thickness of about 1,000 to 5,000 Å.

Thereafter, the planarizing film 140 is etched using a photo-etching process, to form a contact hole, through which one of the source electrode 115 and drain electrode 116 is exposed (In the illustrated case, the drain electrode 116 is exposed through the contact hole.).

Subsequently, the first electrode 150 is formed on the planarizing film 140 such that it covers the TFT 110 while being electrically connected to the drain electrode 116 via the contact hole.

Hereinafter, the process for forming the first electrode 150 will be described in detail.

A single material layer or at least two material layers are deposited using one or more materials selected from titanium (Ti), molybdenum (Mo), chromium (Cr), copper (Cu), gold (Au), nickel (Ni), silver (Ag), tantalum (Ta), aluminum (Al), aluminum-neodymium (AlNd), and tungsten (W). The material layer or layers are then selectively removed using a photo-etching process, thereby forming the first electrode 150.

The thickness and material of the first electrode 150 are controlled so that the first electrode 150 can not only shield natural light, but also have an X-ray transmissivity of 0.001 to 1.0%.

Thereafter, an inorganic insulating film, which is comprised of a silicon nitride film or a silicon oxide film, is deposited to a thickness of about 1,000 to 2,000 Å over the entire upper surface of the resulting structure. The inorganic insulating film is then patterned such that it remains only between adjacent unit pixel regions, to form the pixel isolation film 155.

As shown in FIG. SE, the hole injection layer 160, hole transfer layer 165, emitting layer 170, electron transfer layer 180, and electron injection layer 185 are then sequentially laminated over the entire upper surface of the resulting structure including the first electrode 150, thereby forming the organic luminescence layer. Thereafter, the second electrode 190 of the organic electroluminescence device is formed to a desired thickness over the entire upper surface of the resulting structure.

The formation of the hole injection layer 160 is achieved by depositing copper phthalocyanine (CuPC) to a thickness of 10 to 30 nm. The formation of the hole transfer layer 165 is achieved by depositing 4.4+-bis[N-(1-naphthyl)-N-phenthylamino]-biphenyl (NPB) to a thickness of 30 to 60 nm. The emitting layer 170 is formed using organic luminescence materials selected in accordance with red, green, and blue pixels, and added with a dopant, if necessary.

At least one of the deposition processes for forming the organic luminescence layer and second layer is carried out using electron beams, namely, X-rays.

When both the organic luminescence layer and second layer are formed using X-rays, it is possible to carry out the deposition processes thereof in the same chamber, and thus to achieve an enhancement in the luminescence characteristics of the organic luminescence layer. That is, when the second electrode is deposited over the structure, on which the organic luminescence layer has been deposited, using a sputtering method, after the structure is fed to sputtering equipment, a degradation in luminescence characteristics may occur because the organic luminescence layer is exposed to the atmosphere. Also, in the latter case, there is a complexity in deposition process.

Although electron beams are used in both the processes for forming the organic luminescence layer and second electrode, it is possible to prevent the active layer of the TFT 110 from being damaged by X-rays because the active layer of the TFT is covered by the first electrode 150.

Meanwhile, it may be possible to protect the TFT from natural light or X-rays without forming the first electrode 150, which extends over the TFT, to cover the TFT or forming the shield layer 200 over the TFT, as in the first and second embodiments. This will be described in conjunction with an organic electroluminescence device according to a third embodiment of the present invention.

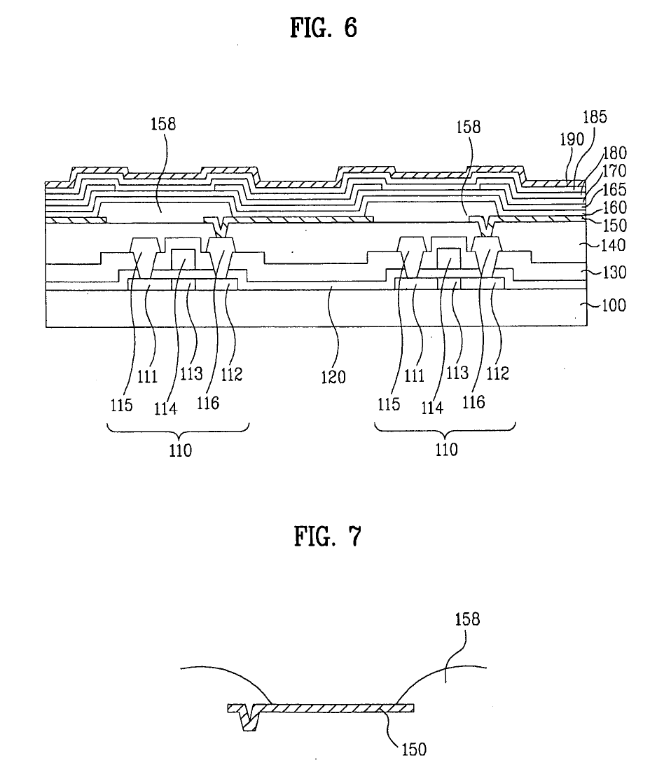

As shown in FIGS. 6 and 7, the organic electroluminescence device according to the third embodiment of the present invention has a structure in which a plurality of TFTs 110, a planarizing film 140, and a luminescence device including components 150, 160, 165, 170, 180, 185, and 190 are sequentially laminated on a transparent substrate 100.

The transparent substrate 100 may be made of glass, quartz, or sapphire. Although not shown, an insulating layer is formed between the transparent substrate 100 and the TFTs 110, to prevent impurity contained in the substrate 100 from penetrating into active layers of the TFTs 110.

Each TFT 110 includes an active layer formed on the transparent substrate 100 while being defined with a source region 111, a drain region 112, and a channel region 113, a gate insulating film 120 formed over the entire upper surface of the resulting structure including the active layer, a gate electrode 114 formed on a portion of the gate insulating film 120 arranged over the channel region 113, and an interlayer insulating film 130 formed over the entire upper surface of the resulting structure including the gate electrode 114. Each TFT 110 also includes a source electrode 115 and a drain electrode 116 formed on the interlayer insulating film 130 while extending through contact holes formed to reach the source region 111 and drain region 112, respectively, so that the source electrode 115 and drain electrode 116 are electrically connected to the source region 111 and drain region 112, respectively.

The planarizing film 140 may be made of an organic insulating film such as an acryl-based organic compound, polyimide, benzocyclobutene (BCB), or perfluorocyclobutane (PFCB). Alternatively, the planarizing film 140 may be made of an inorganic insulating material such as silicon nitride.

The luminescence device includes a first electrode 150 (anode electrode) formed on the planarizing film 140 such that it is electrically connected to the drain electrode 116 via a contact hole formed through the planarizing film 140 to expose the drain electrode 116. The luminescence device also includes an insulating film 158 formed on a portion of the planarizing film 140 arranged over each TFT 110, an organic luminescence layer including components 160, 165, 170, 180, and 185 formed over the entire upper surface of the resulting structure including the first electrode 150 and insulating film 158, and a second electrode 190 (cathode) formed on the organic luminescence layer.

The first electrode 150 is made of a transparent conductive material capable of transmitting light, for example, indium tin oxide (ITO) or indium zinc oxide (IZO). The insulating film 158 is formed to cover each TFT 110. The insulating film 158 overlaps with opposite ends of the first electrode 150.

The portions of the insulating film 158 covering the ends of the first electrode 150 have a width corresponding to 3 to 10% of the width of the first electrode 150. That is, although the insulating film 158 covers the first electrode 150, the first electrode 150 has an aspect ratio of 80 to 95%. The size of the first electrode 150 and the overlapping width of the insulating film 158 depend on the pixel size of the organic electroluminescence device. For example, when it is assumed that the size of the first electrode 150 is 100 μm, the insulating film 158 covers each end of the first electrode 150 by a width of 3 to 10 μm. The insulating film 160 may be made of an inorganic insulating material such as a silicon nitride (SiNₓ) or a silicon oxide (SiO₂).

If the width of the insulating film 158 covering the first electrode 150 is more than the above-described value, the aperture ratio of the organic electroluminescence device may be excessively reduced. On the other hand, if the width of the insulating film 158 covering the first electrode 150 is more than the above-described value, there may be a difficulty in the manufacturing processes, as will be described later.

The organic luminescence layer includes a hole injection layer 160, a hole transfer layer 165, an emitting layer 170, an electron transfer layer 180, and an electron injection layer 185, which are sequentially laminated in that order.

The electron transfer layer 180 is arranged between the emitting layer 170 and the second electrode 190. Accordingly, most electrons injected from the second electrode 190 into the emitting layer 170 tend to move toward the first electrode 150, in order to recombine with holes. On the other hand, the hole transfer layer 165 is arranged between the first electrode 150 and the emitting layer 170. Accordingly, the electrons injected into the emitting layer 170 are blocked by the interface between the emitting layer 170 and the hole transfer layer 165, so that they can no longer move toward the first electrode 150. As a result, the electrons stay only in the emitting layer 170. Thus, an enhancement in recombination efficiency is achieved.

Since the insulating layer 158 covers the ends of the first electrode 150 by a desired width in the above-described organic electroluminescence device, light emitted from the emitting layer during operation of the organic electroluminescence device is prevented from being transmitted to the TFTs. It is also possible to protect the TFTs from ultraviolet rays generated during the formation of the emitting layer and cathode. Thus, a degradation in the performance of the TFTs can be prevented.

Hereinafter, a method for manufacturing the organic electroluminescence device having the above-described structure will be described.

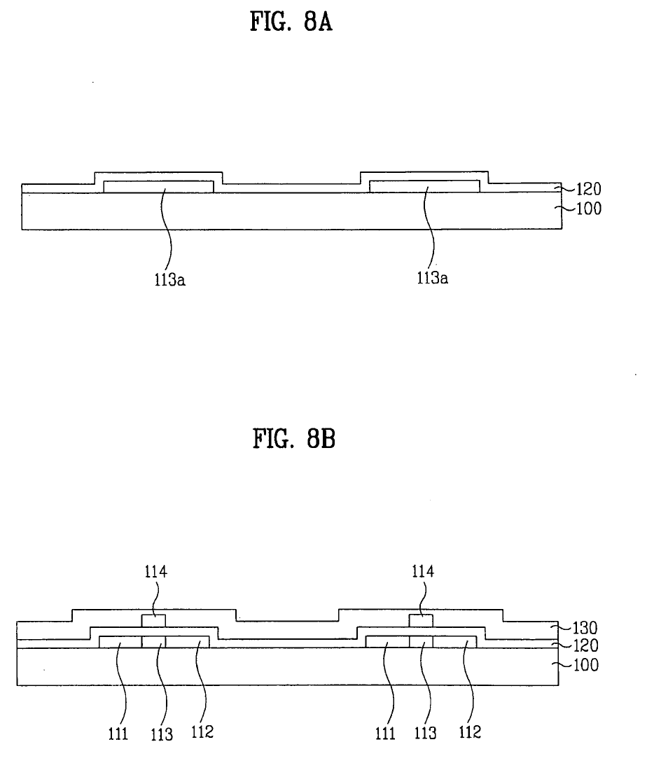

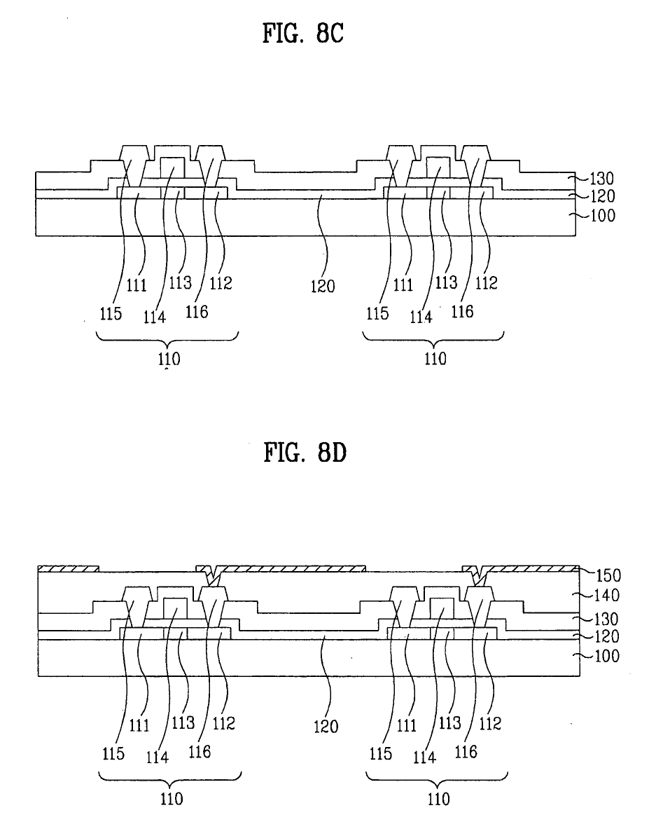

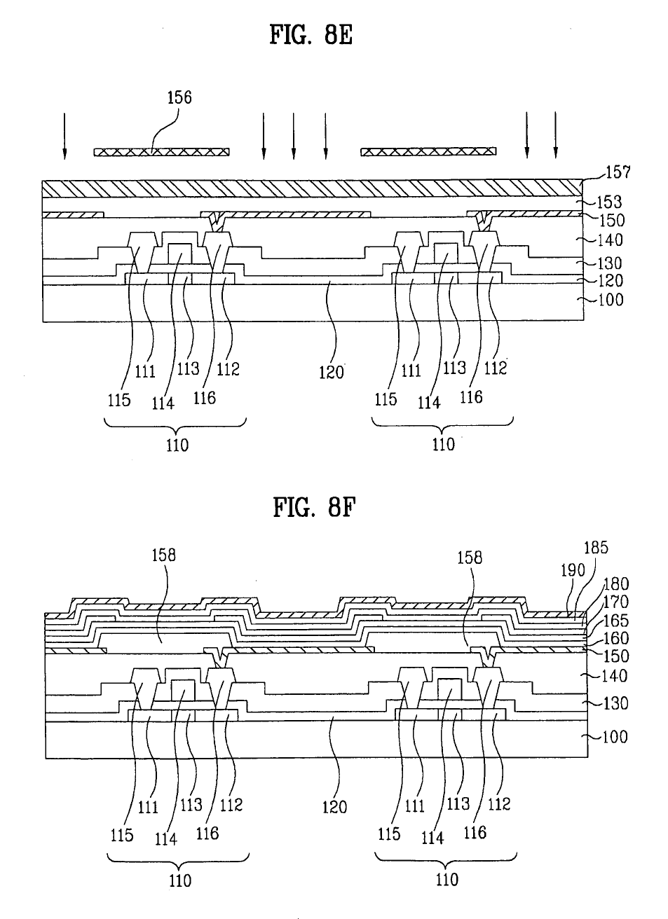

FIGS. 8A to 8F are sectional views illustrating sequential processes of the method for manufacturing the organic electroluminescence device.

As shown in FIG. 8A, an amorphous silicon film is formed to a thickness of about 200 to 800A over the transparent substrate 100, which is made of glass, quartz, or sapphire, using a low pressure chemical vapor deposition method or a plasma enhanced chemical vapor deposition method. The amorphous silicon film is then crystallized into a polysilicon film, using a laser annealing method or the like. Of course, a polysilicon film may be directly deposited, in place of the amorphous silicon film.

Thereafter, the polysilicon film is selectively removed using a photolithography method, to form the active layer 113a of each TFT.

The gate insulating film 120 is then deposited over the entire upper surface of the resulting structure including the active layer 113a.

As shown in FIG. 8B, aluminum-neodymium (AlNd) is deposited to a thickness of about 1,500 to 5,000 Å over the entire upper surface of the resulting structure. The deposited aluminum-neodymium (AlNd) is selectively removed, to form the gate electrode 114 on a portion of the gate insulating film 120 arranged over the active layer 113a.

Using the gate electrode 114 as a mask, impurity ions are implanted into the active layer 113a. The injected impurity ions are then activated. In order to activate the injected impurity ions while recovering the silicon layer from possible damage, a laser annealing process or a furnace annealing process is carried out. As a result, the source region 111 and drain region 112 are formed in the active layer 113a at opposite sides of the gate electrode 114. In this case, the channel region 113 is naturally formed in the active layer 113a between the source region 111 and the drain region 112.

Thereafter, the interlayer insulating film 130 is formed over the entire upper surface of the resulting structure.

As shown in FIG. 8C, the gate insulating film 120 and interlayer insulating film 130 are selectively removed such that the source region 111 and drain region 112 are exposed, thereby forming contact holes.

A conductive layer is deposited to a thickness of 3,000 to 6,000 Å over the interlayer insulating film 130, using molybdenum-tungsten (MoW) or aluminum-neodymium (AlNd), and then patterned using a photo-etching process, to form the source electrode 115 and drain electrode 116 on the interlayer insulating film 130 such that they are electrically connected to the source region 111 and drain region 112, respectively.

The formation of the source electrode 115 and drain electrode 116 may be achieved using a sputtering method or a deposition method using electron beams. Alternatively, a conductive material such as aluminum (Al) may be deposited to a thickness of 200 to 500 nm, to form the source electrode 115 and drain electrode 116.

As shown in FIG. 8D, the planarizing film 140 is then formed over the entire upper surface of the interlayer insulating film 130 including the source electrode 115 and drain electrode 116. The planarizing film 140 functions to planarize the luminescence device, which will be subsequently formed. The formation of the planarizing film 140 is achieved by depositing an organic or inorganic insulating film to a thickness of about 1,000 to 5,000 Å.

Thereafter, the planarizing film 140 is selectively etched using a photo-etching process, to form a contact hole, through which the drain electrode 116 is exposed. A transparent conductive film is deposited over the planarizing film 140, using ITO or IZO, and then patterned in accordance with a photo-etching process, thereby forming the first electrode 150 of the luminescence device such that it is electrically connected to the drain electrode 116 via the contact hole.

Thereafter, as shown in FIG. 8E, an insulating material 153 such as a silicon nitride or a silicon oxide is deposited to a thickness of about 1,000 to 2,000 Å over the entire upper surface of the resulting structure including the first electrode 150. The deposited insulating material 153 is then patterned to form the insulating film 158. The patterning of the insulating material 153 is achieved using a selective light exposure and development process.

That is, as shown in FIG. 8E, a photoresist film 157 is deposited over the insulating material 153. The photoresist film 157 is subjected to a selective light exposure under the condition in which a mask 156 is arranged on the photoresist film 157, thereby forming a pattern of the photoresist film 157. The mask 156 has a pattern to expose a region between the adjacent first electrodes 150 and portions of the ends of each first electrode 150.

Using the patterned photoresist film 157 as a mask, the insulating material 153 is selectively removed, to form the insulating film 158.

Where the first electrode 150 has a line width of 100 μm, the mask 156 exposes each end of the first electrode (anode) 150 by a width of 3 to 10 μm. If the mask 156 exposes each end of the first electrode 150 by a width of less than 3 μm, the insulating film 158 may be patterned such that it does not cover the first electrode 150, due to errors in the light exposure process.

The insulating film 158 formed in accordance with the etching process using the mask 156 covers the ends of the first electrode 150 by a width corresponding to 3 to 10% of the width of the first electrode 150. That is, the first electrode 150 has an aspect ratio of 80 to 95%. The size of the first electrode 150 and the overlapping width of the insulating film 158 depend on the pixel size of the organic electroluminescence device. For example, when it is assumed that the size of the first electrode 150 is 100 μm, the insulating film 158 covers each end of the first electrode 150 by a width of 3 to 10 μm.

Thereafter, as shown in FIG. 8F, the photoresist film 157 is removed. The hole injection layer 160, hole transfer layer 165, emitting layer 170, electron transfer layer 180, and electron injection layer 185 are then sequentially laminated over the resulting structure, thereby forming the organic luminescence layer. Subsequently, the second electrode (cathode) 190 of the organic electroluminescence device is formed to a desired thickness over the entire upper surface of the resulting structure.

The formation of the hole injection layer 160 is achieved by depositing copper phthalocyanine (CuPC) to a thickness of 10 to 30 nm. The formation of the hole transfer layer 165 is achieved by depositing 4.4′-bis[N-(1-naphthyl)-N-phenthylamino]-biphenyl (NPB) to a thickness of 30 to 60 nm. The emitting layer 170 is formed using organic luminescence materials selected in accordance with red, green, and blue pixels, and added with a dopant, if necessary.

Although the substrate may be exposed to ultraviolet rays during the formation of the organic luminescence layer and second electrode (cathode) 190, the insulating film 158 shields the organic luminescence layer and second electrode (cathode) 190 from the ultraviolet rays because the insulating film 158 is formed between the adjacent first electrodes 150 while covering portions of the opposite ends of each first electrode 150. Accordingly, it is possible to prevent a degradation in the performance of each TFT, and to shield light emitted from the emitting layer.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

The organic electroluminescence device and manufacturing method thereof according to the present invention can preserve the characteristics of the TFTs in the completed product and during the manufacturing processes. Thus, it is possible to achieve an enhancement in the performance and lifespan of the organic electroluminescence device.

What is claimed is:

1. An organic electroluminescence device comprising:
a substrate;
a semiconductor layer on the substrate, the semiconductor layer including a source region, a channel region, and a drain region;
a gate insulating film on the substrate including the semiconductor layer, the gate insulating film including first contact holes respectively arranged on the source and drain regions;
a gate electrode on a portion of the gate insulating film over the channel region;
an interlayer insulating film on an entire upper surface of the gate insulating film including the gate electrode, the interlayer insulating film including second contact holes respectively arranged on the source and drain regions;
source and drain electrodes on the interlayer insulating film such that the source and drain electrodes are electrically connected to the source and drain regions via the first and second contact holes, respectively;
a planarizing film on an entire upper surface of the resulting structure including the source and drain electrodes, the planarizing film including a third contact hole arranged on the drain electrode;
a first electrode of a luminescence device on the planarizing film such that the first electrode covers the semiconductor layer while being electrically connected to the drain electrode via the third contact hole;
an organic luminescence layer on the first electrode; and
a second electrode of the luminescence device on the organic luminescence layer.

2. The organic electroluminescence device according to claim 1, wherein the first electrode is made of one or more selected from a group consisting of titanium (Ti), molybdenum (Mo), chromium (Cr), copper (Cu), gold (Au), nickel (Ni), silver (Ag), tantalum (Ta), aluminum (Al), aluminum-neodymium (AlNd), and tungsten (W), to have a single layer structure or a multilayer structure.

3. The organic electroluminescence device according to claim 1, wherein the first electrode has an X-ray transmissivity of 0.001 to 1.0%.

4. An organic electroluminescence device comprising:
a transparent substrate;
a semiconductor layer on the substrate, the semiconductor layer including a source region, a channel region, and a drain region;
a gate insulating film on the substrate including the semiconductor layer, the gate insulating film including first contact holes respectively arranged on the source and drain regions;
a gate electrode on a portion of the gate insulating film over the channel region;
an interlayer insulating film on an entire upper surface of the gate insulating film including the gate electrode, the interlayer insulating film including second contact holes respectively arranged on the source and drain regions;
source and drain electrodes on the interlayer insulating film such that the source and drain electrodes are electrically connected to the source and drain regions via the first and second contact holes, respectively;
a planarizing film on an entire upper surface of the resulting structure including the source and drain electrodes, the planarizing film including a third contact hole arranged on the drain electrode;
a first electrode of a luminescence device on the planarizing film such that the first electrode is electrically connected to the drain electrode via the third contact hole;
a shield layer over or beneath the first electrode such that the shield layer covers the semiconductor layer;
an organic luminescence layer on the first electrode; and
a second electrode of the luminescence device on the organic luminescence layer.

5. The organic electroluminescence device according to claim 4, wherein the shield layer is made of one or more selected from a group consisting of titanium (Ti), molybdenum (Mo), chromium (Cr), copper (Cu), gold (Au), nickel (Ni), silver (Ag), tantalum (Ta), aluminum (Al), aluminum-neodymium (AlNd), and tungsten (W), to have a single layer structure or a multilayer structure.

6. The organic electroluminescence device according to claim 4, wherein the shield layer has an X-ray transmissivity of 0.001 to 1.0%.

7. The organic electroluminescence device according to claim 4, wherein the first electrode is made of indium tin oxide (ITO) or indium zinc oxide (IZO).

8. An organic electroluminescence device comprising a plurality of cells each including a display area provided with a first transistor and a luminescence device, and a non-display area provided with a second transistor for driving the cell,
wherein the luminescence device comprises a first electrode, a luminescence layer, and a second electrode; and
wherein the first electrode covers the first and second transistors.

9. The organic electroluminescence device according to claim 8, wherein the first electrode is made of one or more selected from a group consisting of titanium (Ti), molybdenum (Mo), chromium (Cr), copper (Cu), gold (Au), nickel (Ni), silver (Ag), tantalum (Ta), aluminum (Al), aluminum-neodymium (AlNd), and tungsten (W), to have a single layer structure or a multilayer structure.

10. The organic electroluminescence device according to claim 8, wherein the first electrode has an X-ray transmissivity of 0.001 to 1.0%.

11. An organic electroluminescence device comprising:
a thin film transistor on a transparent substrate, the thin film transistor including a gate electrode, a source electrode, and a drain electrode;
a first electrode of a luminescence device formed to be electrically connected to the drain electrode;
an insulating film formed to cover the thin film transistor and to overlap opposite ends of the first electrode;
a luminescence layer on the first electrode, the luminescence layer emitting light as electrons and holes disappear after being coupled in pairs; and
a second electrode of the luminescence device on the luminescence layer.

12. The organic electroluminescence device according to claim 11, wherein portions of the insulating film covering the opposite ends of the first electrode have a width corresponding to 3 to 10% of a width of the first electrode.

13. The organic electroluminescence device according to claim 11, wherein the insulating film covers the opposite ends of the first electrode such that the first electrode has an aspect ratio of 80 to 95%.

14. The organic electroluminescence device according to claim 11, wherein the insulating film is made of SiNₓ or SiO₂.

15. A method for manufacturing an organic electroluminescence device, comprising:
forming, on a substrate, a semiconductor layer including a source region, a channel region, and a drain region;
forming a gate insulating film on the substrate including the semiconductor layer;
forming a gate electrode on a portion of the gate insulating film over the channel region;
forming an interlayer insulating film on an entire upper surface of the gate insulating film including the gate electrode;
selectively removing the gate insulating film and the interlayer insulating film, thereby forming first contact holes respectively arranged on the source and drain regions;
forming source and drain electrodes on the interlayer insulating film such that the source and drain electrodes are electrically connected to the source and drain regions via the first contact holes, respectively;
forming a planarizing film on an entire upper surface of the resulting structure including the source and drain electrodes;
selectively removing the planarizing film, thereby forming a second contact hole on the drain electrode;
forming a first electrode of a luminescence device on the planarizing film such that the first electrode covers the semiconductor layer while being electrically connected to the drain electrode via the second contact hole;
forming an organic luminescence layer on the first electrode; and
forming a second electrode of the luminescence device on the organic luminescence layer.

16. The method according to claim 15, wherein the first electrode is made of one or more selected from a group consisting of titanium (Ti), molybdenum (Mo), chromium (Cr), copper (Cu), gold (Au), nickel (Ni), silver (Ag), tantalum (Ta), aluminum (Al), aluminum-neodymium (AlNd), and tungsten (W), to have a single layer structure or a multilayer structure.

17. The method according to claim 15, wherein a material of the first electrode and a thickness of the first electrode are controlled such that the first electrode has an X-ray transmissivity of 0.001 to 1.0%.

18. A method for manufacturing an organic electroluminescence device, comprising:
forming a semiconductor layer on a transparent substrate, the semiconductor layer including a source region, a channel region, and a drain region;
forming a gate insulating film on the substrate including the semiconductor layer;
forming a gate electrode on a portion of the gate insulating film over the channel region;
forming an interlayer insulating film on an entire upper surface of the gate insulating film including the gate electrode;
selectively removing the gate insulating film and the interlayer insulating film, thereby forming first contact holes respectively arranged on the source and drain regions;
forming source and drain electrodes on the interlayer insulating film such that the source and drain electrodes are electrically connected to the source and drain regions via the first contact holes, respectively;
forming a planarizing film on an entire upper surface of the resulting structure including the source and drain electrodes;
selectively removing the planarizing film, thereby forming a second contact hole arranged on the drain electrode;
forming a first electrode of a luminescence device on the planarizing film such that the first electrode is electrically connected to the drain electrode via the second contact hole;
forming a shield layer over or beneath the first electrode such that the shield layer covers the semiconductor layer;
forming an organic luminescence layer on the first electrode; and
forming a second electrode of the luminescence device on the organic luminescence layer.

19. The method according to claim 18, wherein the shield layer is made of one or more selected from a group consisting of titanium (Ti), molybdenum (Mo), chromium (Cr), copper (Cu), gold (Au), nickel (Ni), silver (Ag), tantalum (Ta), aluminum (Al), aluminum-neodymium (AlNd), and tungsten (W), to have a single layer structure or a multilayer structure.

20. The method according to claim 18, wherein a material of the first electrode and a thickness of the shield layer are controlled such that the first electrode has an X-ray transmissivity of 0.001 to 1.0%.

21. The method according to claim 18, wherein the first electrode is made of indium tin oxide (ITO) or indium zinc oxide (IZO).

22. A method for manufacturing an organic electroluminescence device, comprising:
forming a thin film transistor on a transparent substrate, the thin film transistor including a gate electrode, a source electrode, and a drain electrode;
forming a planarizing film on an entire upper surface of the substrate including the thin film transistor, and forming a contact hole through the planarizing film such that the drain electrode is exposed through the contact hole;
forming a first electrode of a luminescence device such that the first electrode is electrically connected to the drain electrode via the contact hole;
forming an insulating film on the planarizing film such that the insulating film covers the thin film transistor and overlaps opposite ends of the first electrode; and
forming a second electrode of the luminescence device on the first electrode.

23. The method according to claim 22, wherein portions of the insulating film covering the opposite ends of the first electrode have a width corresponding to 3 to 10% of a width of the first electrode.

24. The method according to claim 22, wherein the insulating film is patterned to cover the opposite ends of the first electrode such that the first electrode has an aspect ratio of 80 to 95%.

25. The method according to claim 22, wherein the insulating film is formed by laminating SiNₓ or SiO₂ to a thickness of 1,000 to 2,000 Å.
